(19) United States
(12) Patent Application Publication
(10) Pub. No.: US 2012/0152197 A1
(43) Pub. Date: Jun. 21, 2012

(54) Water Ion Splitter and Fuel Cell

(76) Inventor: Charles Inskeep, Descanso, CA (US)

(21) Appl. No.: 12/970,425

(22) Filed: Dec. 16, 2010

(51) Int. Cl. C25B 9/00; F02B 43/00; C25B 1/02

(52) U.S. Cl. 123/1 A; 204/278; 204/228.4; 204/273

(57) ABSTRACT

This procedure allows for the splitting of the water molecule into its basic components of two hydrogen gas ions, one oxygen gas ion, and two free electrons. Polarized electrodes are placed in a water bath then subjected to pulsed voltage fields at sub resonant frequencies which results in the fission process of the water molecule. The Hydrogen gas and Oxygen gas (Hydroxy) can provide fuel to a combustion process where only clean water is exhausted. The Hydrogen and Oxygen may also be separated and feed a fuel cell that generates clean electricity. The free electrons can be extracted and provide additional electrical power.

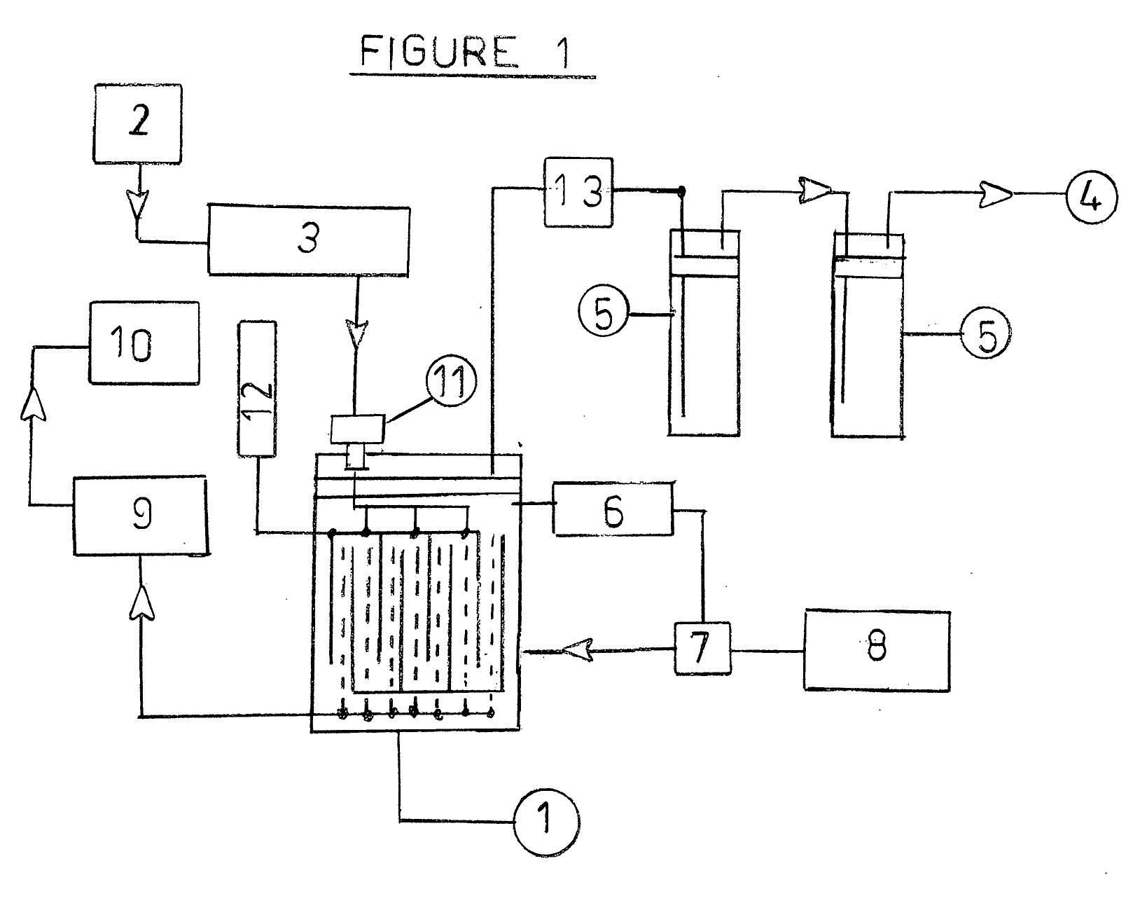

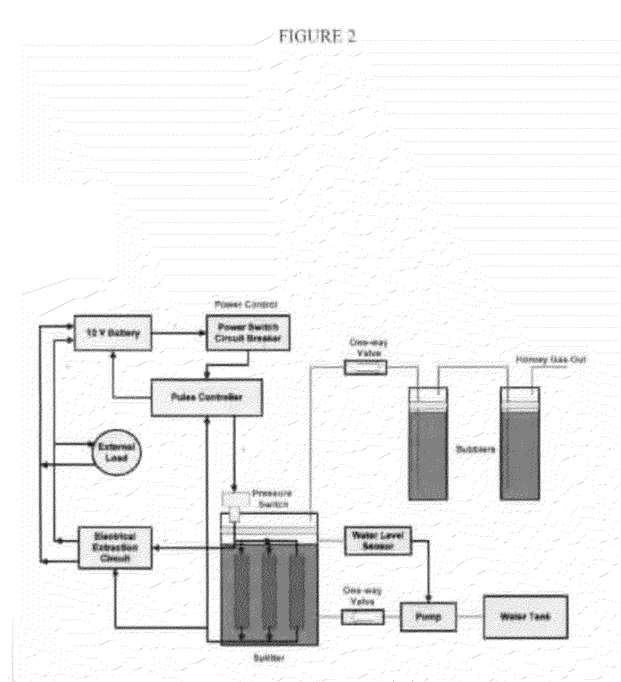

The voltage pulse generator generates electrostatic pulses that are applied to the bi-polar electrodes submerged in a water bath. The power for this generator can be obtained from a variety of sources. The application here utilizes a 12 volt dc supply.

The output of this pulse generator is fed to the electrodes submerged in a water bath. The output may be varied from 10 Vdc to 12 kVdc, a pulse duty cycle from 5% to 90%, and a frequency from 10 to 45 kHz. The electrode configuration in this water bath appears electrically as a capacitor. The external inductor connected in the circuit is tuned to make the circuit resonant at a sub-resonant frequency of the water. As resonance is approached, very small current is supplied to the electrodes from the pulse generator due to the high “Q” of this circuit. The variables available as outputs from this generator are used to modulate the gas output from the water bath. A high intensity electrostatic field force initiates the fission process.

Hydrogen is a carrier of energy. Energy is not created in this system. Due to the electrostatic field generated across the bi-polar electrodes, the Hydrogen energy is transformed into monotonic hydrogen ions. Fission takes place due to the driving force of the resonant frequency applied. It is necessary to monitor and control the outputs of the pulse generator since variables in temperature, volume of the water, impurities in the water, as well as other physical changes all affect the resonant frequency we may require. Modulation of the fission process can be accomplished by controlling the generator output variables.

The water bath container is a sealed unit such that the gasses bubble to the top and may escape through a tube and a one way valve to a bubbler. These bubblers are employed in order to keep the gasses from back flashes that may occur downstream. A safety pressure switch is incorporated in the gas release area which shuts down the operation at pressures above 5 PSI.

The free electrons that are released from each water molecule are captured with the electron extraction circuit which includes a screen conductor between the bi-polar electrodes of the bath configuration.

*DOUBLE SPACED PER NOTICE OF INCOMPLETE REPLY 06/10/2011*

1. Oxygen Ions, Hydrogen Ions, and free electrons are released from water molecules with the application of pulsed electrical charge applied to a bipolar, resonant configuration of elements submerged in a water bath. A variable inductor is added to this circuit to achieve a high “Q” resonance applicable to the water bath configuration.

2. Modulation of the quantity of Hydrogen Ions, Oxygen Ions, and free electrons is effected by the frequency of the pulses, the duty cycle of the pulses and the voltage of the pulses applied to the submerged configuration. The frequency is a sub-multiple of the water bath configuration (including the resonant frequency of the water itself).

3. Free electrons are collected through an electron extraction circuit. This circuit is required to clear the free electrons as they are generated in order to keep the process operating efficiently.

4. The water bath configuration must be tuned to the applicable resonance frequency in order to take in account variances of water volume, temperature, impurities, and other considerations of variables. This is accomplished with a variable inductor as noted in claim 1, above. Plates or concentric tubes are two available configurations for the bi-polar electrical configurations.

5. Oxygen ions and Hydrogen ions (Hydroxy gas) are extracted to directly fuel a combustion engine. These gas ions may also be separated through magnetic fields to feed a fuel cell which can directly produce electricity.

6. Pressure sensors are utilized to keep the process in a safe operating environment. 5 PSI pressure maximums are employed.

7. Gas bubbler configurations are employed to keep gasses or ignition sparks from leaking back into the system.

8. For utilization as a combustion fuel, Hydroxy gas may be applied directly as noted in claim 5 above. Since only pure water is generated as the exhaust, it is suggested that stainless steel rings and exhaust plumbing material be utilized. Further, it is necessary to adjust the timing since this gas burns 1000 times faster than gasoline.
